(19) United States
(12) Patent Application Publication
(10) Pub. No.: US 2025/0332741 A1
(43) Pub. Date: Oct. 30, 2025

(54) GRIPPING APPARATUS HAVING A COMPRESSING UNIT

(71) Applicant: J.Schmalz GmbH, Glatten (DE)

(72) Inventors: Ralf Stockburger, Glatten (DE); Maik Fiedler, Schorndorf (DE)

(73) Assignee: J.Schmalz GmbH, Glatten (DE)

(21) Appl. No.: 19/192,599

(22) Filed: Apr. 29, 2025

(30) Foreign Application Priority Data
Apr. 30, 2024 (EP) 24 173 426.8

(51) Int. Cl. B25J 15/06

(52) U.S. Cl. CPC B25J 15/0616

(57) ABSTRACT

A gripping apparatus (and method) comprising a gripper base body and at least two lifting units arranged on the gripper base body, each comprising a lifting piston which is adjustable along a lifting axis between an axially retracted configuration and an axially extended configuration, wherein at least one lifting unit is designed as a gripping unit including a gripper which is coupled in terms of movement to the lifting piston for gripping the item, and wherein at least one lifting unit is designed as a compressing unit including a compressing element which is coupled in terms of movement to the lifting piston for exerting a pressure force on an item held by the gripper.

The invention relates to a gripping apparatus for gripping and handling an item and to a method for handling an item with such a gripping apparatus.

Gripping apparatuses are known in many different ways from the prior art. A selection of such gripping apparatuses comprises, for example, mechanical grippers, magnetic grippers and suction grippers.

Suction grippers usually have at least one suction point for suctioning and thus gripping an item. For example, suction grippers are known which have a plurality of suction units which are mounted on a gripper base body so as to be displaceable along a lifting axis between an axially retracted passive configuration and an axially extended active configuration. With such suction grippers, it is possible to flexibly adapt the suction gripper to different geometries of items to be gripped by selectively extending individual suction units.

An important area of application for such suction grippers, but also for gripping apparatuses in general, is the stacking of flat materials, for example the stacking of sheets from a stack of sheets. Here the problem can arise that sheets stacked on one another stick together due to adhesion forces, so that when the top sheet is lifted from a stack, the sheet below it is also lifted.

The invention addresses the object of separating stacked items having different geometries in a structurally simple and cost-effective manner and then being able to handle them reliably.

This object is achieved according to the invention by a gripping apparatus having the features of claim 1. The gripping apparatus is designed for gripping and handling an item, in particular flat material, further in particular sheet metal. In particular, the gripping apparatus is designed for separating flat materials stacked on top of one another, such as sheets or the like.

The gripping apparatus comprises a gripper base body and at least two lifting units arranged on the gripper base body. The lifting units each have a lifting piston which is held, in particular mounted, on the gripper base body so as to be adjustable along a lifting axis between an axially retracted configuration and an axially extended configuration. In particular, the lifting piston is adjustable relative to the gripper base body in an extension direction and in a retraction direction opposite to the extension direction. The retracted configuration and the extended configuration form, in particular, end positions of a displacement path of the lifting piston along the lifting axis.

According to the invention, at least one lifting unit is designed as a gripping unit for gripping an item and at least one lifting unit is designed as a compressing unit (without gripping action) for exerting a pressure force on an item held by the gripper, in particular in the extension direction. Each gripping unit comprises a gripper for gripping the item, which is coupled in terms of movement to the lifting piston and is arranged in particular at the free axial end of the lifting piston. Each compressing unit comprises a compressing element which is coupled in terms of movement to the lifting piston, in particular arranged at the free axial end of the lifting piston, in particular for exerting a pressure force on the item held by the gripper of the at least one gripping unit, in particular in the extension direction. In particular, the compressing element is designed to deform an item held by the gripper, in particular a flat material. Preferably, the gripping unit and compressing unit are arranged next to one another.

The proposed gripping apparatus with compressing unit makes it possible to deform, at least locally, a flat material held by the gripping unit, in particular sheet metal, and thus to release adhesion forces between the item and an item underneath it. This makes it possible to reliably prevent multiple parts from being removed when stacking flat materials in a structurally simple and cost-effective manner. The lift in the lifting piston also allows unevenness and deformations on an item to be gripped to be compensated for, which enables reliable gripping of different types of flat material.

It is conceivable that the compressing unit actively exerts a pressure force on the item, for example by compressing the compressing element onto an item gripped by the gripper by extending the lifting piston. It is also conceivable that the compressing unit only passively exerts a pressure force on the item. For example, it is conceivable that a first portion of an item to be gripped rests against the compressing element and a second portion of the item, spaced apart from the first portion, is displaced relative to the compressing element, in particular in the retraction direction (e.g., in the course of a gripping process by the gripper) and thus the item is locally deformed. In this respect, the compressing element can form a stop for the item.

The compressing element can in principle be designed in different ways. For example, the compressing element can be designed as a compressing pin or compressing button. In particular, the compressing element has a preferably flat contact surface on one end face for contact with the item.

Preferably, the lifting piston of the at least one gripping unit and the lifting piston of the at least one compressing unit, in particular all lifting pistons, can be actuated independently of one another, i.e., can be repeatedly extended and retracted independently of one another. This facilitates flexible controlling of the gripping apparatus. In particular, such an embodiment makes it possible to extend the at least one gripping unit and the at least one compressing unit simultaneously or at different times, selectively. For example, a handling process is conceivable in which first the at least one gripping unit is extended, an item to be gripped is gripped with the gripper of the extended gripping unit, and then the at least one compressing unit is extended in order to deform the gripped item by exerting a pressure force. Handling processes are also conceivable in which the gripping unit and the compressing unit are activated simultaneously, i.e., extended, and then placed together on an item to be gripped.

Within the scope of an advantageous embodiment, the lifting piston of the at least one gripping unit and the lifting piston of the at least one compressing unit, in particular all lifting pistons, can be constructed identically to one another. This enables a structurally simple and cost-effective design. In addition, such a gripping apparatus can be used flexibly, since the lifting pistons can be selectively used as a gripping unit or as a compressing unit as required.

In particular, the lifting pistons can be designed to be connected selectively to a gripper or a compressing element. This can be achieved, for example, by the lifting pistons each having a coupling device, in particular in the form of an interchangeable bushing, at their free ends (i.e., at the ends facing away from the gripper base body) for selectively coupling a gripper or a compressing element. The gripper and compressing element can be arranged flexibly so that the gripping apparatus can be flexibly adapted to different requirements, e.g., depending on the item to be gripped.

It can be advantageous if the at least one gripping unit and the at least one compressing unit are designed such that, in the extended configuration of the relevant lifting piston, a contact surface of the compressing element for contact with the item and a contact surface (gripping surface) of the gripper for contact with the item are arranged flush with one another, i.e., in particular lie on a common plane.

It can also be advantageous if the at least one gripping unit and the at least one compressing unit are designed in such a way, in particular the compressing element is designed and arranged on the lifting piston in such a way, that in the extended configuration of the lifting piston the contact surface of the compressing element protrudes beyond the contact surface of the gripper axially along the lifting axis in the extension direction.

It is particularly advantageous if the compressing element is mounted on the lifting piston such that its position along the lifting axis is adjustable, or is designed to be mountable on the lifting piston in different positions along the lifting axis. In this way, the relative position of the gripper and the compressing element can be adjusted particularly easily as required. In particular, the compressing element has, on its end face facing away from the lifting piston, a contact surface (pressing surface) for contact with the item, wherein the compressing element is held on the lifting piston such that a position of the contact surface is adjustable along the lifting axis.

Furthermore, it can be advantageous if the compressing element is mounted on the lifting piston releasably in a non-destructive manner. This makes it possible to easily replace the compressing element, for example in case of wear, or to replace it with a differently shaped compressing element, for example depending on the item to be gripped.

For example, it is conceivable that the compressing element can be inserted or screwed into the lifting piston. It is also conceivable that the compressing element can be plugged or screwed onto the lifting piston. One possible implementation can be that the compressing element has a threaded portion which can be screwed into an internal thread of the lifting piston or screwed onto an external thread of the lifting piston.

The gripper can in principle be designed in different ways. In an advantageous embodiment, the gripper can assume a passive configuration in which no gripping force is exerted on an item and an active configuration in which a gripping force is exerted on the item. In this respect, the gripper can be activated and deactivated as required. It is particularly advantageous if the gripping unit is designed such that the gripper is in the passive configuration when the retracted configuration of the lifting piston is used and is transferred to the active configuration by extending the lifting piston from the retracted configuration to the extended configuration. In this respect, the gripper can be activated by extending the lifting piston and thus a gripping force can be provided, which simplifies the control and design of the gripping apparatus.

It is particularly preferred if the gripper of at least one gripping unit is designed as a suction gripper for suctioning an item to be gripped. In this respect, at least one gripping unit can be a suction gripping unit. Preferably, the suction gripper can be subjected to negative pressure through the lifting piston. In particular, the suction gripping unit can be designed such that in the extended configuration of the lifting piston the suction gripper is supplied with negative pressure, and in particular in the retracted configuration a negative pressure supply is interrupted.

The suction gripper can be designed in different ways. In particular, the suction gripper can have one or more suction points for suctioning the item. For example, it is conceivable that the suction gripper is designed as an elastomer suction unit comprising at least one suction body. The suction body can be plugged or screwed onto the lifting piston. In embodiments with multiple gripping units, it is conceivable that different gripping units have different suction grippers, in particular suction bodies of different sizes, or have a different number of suction bodies.

Within the scope of an advantageous embodiment of the gripping apparatus, the gripping apparatus can have, in particular on the gripper base body, a negative pressure connection for connection to a negative pressure supply. The gripper base body can have an in particular integrated negative pressure distribution system for distributing negative pressure to the lifting units.

In embodiments with suction grippers, the gripping unit is preferably designed such that in the extended configuration of the lifting piston, a flow connection is established between the negative pressure connection and the suction gripper and in the retracted configuration of the lifting piston, this flow connection is blocked. For example, a shut-off device can be provided for shutting off and releasing the flow path between the negative pressure connection and the suction gripper, which assumes a blocking position in the retracted configuration of the lifting piston and is transferred into a release position by extending the lifting piston into the extended configuration. In this respect, the suction point can be activated by extending the lifting piston. Preferably, the flow cross sections are designed so that a system negative pressure does not collapse if individual suction points are unoccupied or are leaky.

In a general aspect, the lifting pistons of the lifting units (independently of whether they are ultimately formed from a gripping unit or a compressing unit) can each have an internal negative pressure channel which, in the extended configuration, is connected in terms of flow to the negative pressure connection. In particular, in the extended configuration of the lifting piston, a flow connection is established between the negative pressure connection and the suction gripper, and in the retracted configuration of the lifting piston this flow connection is blocked. The negative pressure channel can open out in particular at the end face facing away from the gripper base body.

With such an embodiment of the gripping apparatus, the suction gripper of an optional suction gripping unit can then be supplied with negative pressure via the negative pressure channel of the lifting piston connected to it. The compressing element of the at least one compressing unit can then be arranged on the lifting piston so as to seal the negative pressure channel.

It can also be advantageous if the gripper of at least one gripping unit is designed as a magnetic gripper. Such an embodiment can be particularly advantageous when gripping metal sheets, since magnetic grippers can provide a high holding force in a comparatively small installation space.

The extension and retraction of the lifting pistons can in principle be done in different ways. Preferably, the lifting pistons can be moved from the retracted configuration into the extended configuration, in particular independently of one another, by pressure actuation, in particular by compressed air actuation. In this respect, the lifting pistons can be adjusted along the lifting axis by applying a pressure (negative pressure or positive pressure) acting along the lifting axis.

Particularly preferred are embodiments in which the lifting piston can be displaced in the extension direction by applying compressed air, in particular can be transferred from the retracted configuration into the extended configuration. In an exemplary implementation, the gripper base body can have a compressed air connection and a compressed air distribution system for distributing the compressed air to the lifting units.

Within the scope of an advantageous development, the gripping apparatus can also have, in particular as part of the compressed air distribution system, a valve device which is designed to control a compressed air supply to the lifting pistons, in particular independently of one another, in particular to block or release a flow connection between the lifting pistons and the compressed air connection as required. The valve device can in particular have a separate compressed air valve for each lifting unit.

Furthermore, it can be advantageous if the gripping apparatus has a control device, in particular a control board, which is designed to control the valve device. The gripping apparatus can in this respect have its own, in particular autonomous, control system. The control device can communicate, for example via a wireless connection, with a higher-level control device, for example a handling system in which the gripping apparatus is integrated.

The valve device and/or the control device can be arranged in or on the gripper base body. Preferably, the valve device and/or the control device are provided in the gripper base body. In this way, the gripping apparatus can be divided into a control assembly (valve device+optional control device) and a lifting unit assembly (lifting units). In the case of spare parts, the two assemblies can then be replaced separately.

The lifting units can be designed such that the lifting pistons are loaded, in particular spring-loaded, into the retracted configuration. In particular, the lifting units can be designed such that they are automatically transferred, for example by the spring action described above, into the retracted configuration when the pressure is removed. In this respect, in an initial configuration the lifting units can be in the retracted configuration.

In an embodiment with at least one suction gripping unit, it is also conceivable that the lifting pistons are designed such that the lifting pistons are held in the extended configuration by a negative pressure applied to the suction gripper.

Preferably, the lifting units are arranged on the gripper base body such that the lifting axes of the lifting units run parallel to one another. In this way, a particularly compact arrangement is created which is particularly suitable for gripping flat components such as sheet metal.

The lifting pistons can each be mounted in a respective lifting unit housing. The lifting unit housing can extend longitudinally along the lifting axis, which facilitates a compact arrangement of a plurality of lifting units next to one another. The lifting unit housing can be designed cylindrically. The lifting unit housing can be part of the gripper base body. The lifting unit housing can be provided separately from the gripper base body and fastened to the gripper base body.

Furthermore, it can be advantageous if a pressure chamber, in particular a negative pressure chamber, is formed between an end of the lifting piston opposite the gripper or the compressing element and an inner housing wall of the lifting unit housing, so that in the active configuration an air cushion can be provided behind the lifting piston, which forms a collision protection when the suction gripper is placed on an item. In this way, both the item and the suction gripper can be protected.

The lifting pistons can be mounted so that they cannot rotate around the lifting axis. For example, it is conceivable that the lifting pistons are secured against rotation by means of interacting circular segments. Such an anti-rotation lock is thus not clamping.

The gripper base body can be formed in one part or in multiple parts. The gripper base body can have a fastening portion for fastening to a support, e.g., a flange plate of a manipulator. The gripper base body can have control and valve units (see below).

The gripping apparatus can also comprise one or more sensors. For example, sensors can be provided to monitor a displacement position (retracted configuration/extended configuration) of the lifting pistons. In embodiments with suction grippers, a sensor can additionally or alternatively be assigned to each suction gripper, in particular to each suction point, via which the suction gripper can be monitored, for example with regard to a functional state (passive/active configuration). For example, a pressure sensor can be provided for each suction gripper to monitor the suction pressure. It is also conceivable that the speed of a handling task is automatically adjusted by ascertaining the holding force as a function of the negative pressure prevailing in the suction gripper. Alternatively or additionally, at least one sensor for distance monitoring or collision warning can also be provided. The sensors can be connected to the optional control device and can be controlled by it.

Within the scope of an advantageous development, a plurality of the gripping apparatuses described above can be combined to form a higher-level gripping module. The gripping apparatuses are preferably arranged next to one another and connected to one another. For example, it is conceivable that the gripper base bodies of the gripping apparatuses are interlocked with one another. The gripping apparatuses can be controlled independently of one another. The gripping apparatuses of the gripping module can be electrically connected to one another.

The advantages and optional features described above in connection with the gripping apparatus as such can also be used in the embodiment of the gripping module.

The invention also relates to a method for handling an item, in particular for separating stacked flat materials, more particularly sheets, using a gripping apparatus as described above. The method comprises the following steps:
extending the lifting piston of at least one gripping unit, in particular so that the gripper coupled to the lifting piston assumes an active configuration;
placing the gripper, which is coupled in terms of movement to the extended lifting piston, onto the item to be gripped and gripping the item using the gripper,
deforming the item, comprising the exerting of a pressure force on the item by at least one compressing unit.

The deformation of the item can be realized in various ways. It is conceivable, for example, that after the item has been gripped using the at least one gripping unit, at least one compressing unit is extended in order to exert the pressure force on the gripped item. In this respect, the exertion of the pressure force can comprise the extension of the at least one compressing unit, in particular after gripping by the at least one gripping unit.

It is also conceivable that the exertion of the pressure force comprises applying the compressing element of the at least one compressing unit to a first portion of the item and subsequently displacing a second portion of the item relative to the compressing element, in particular in the retraction direction. The further displacement of the second portion can, for example, take place during the gripping of the item by the gripper. In this respect, the method can comprise extending at least one compressing unit before the gripping of the item. In an embodiment of the gripping apparatus with a suction gripper, it is conceivable, for example, that a suction process for gripping an item is accompanied by a displacement of the portion of the item suctioned by the suction gripper in the retraction direction, so that during the suction this portion of the item is displaced and thus deformed relative to a portion of the item resting on the compressing element.

The invention is explained in more detail below with reference to the figures, in which:

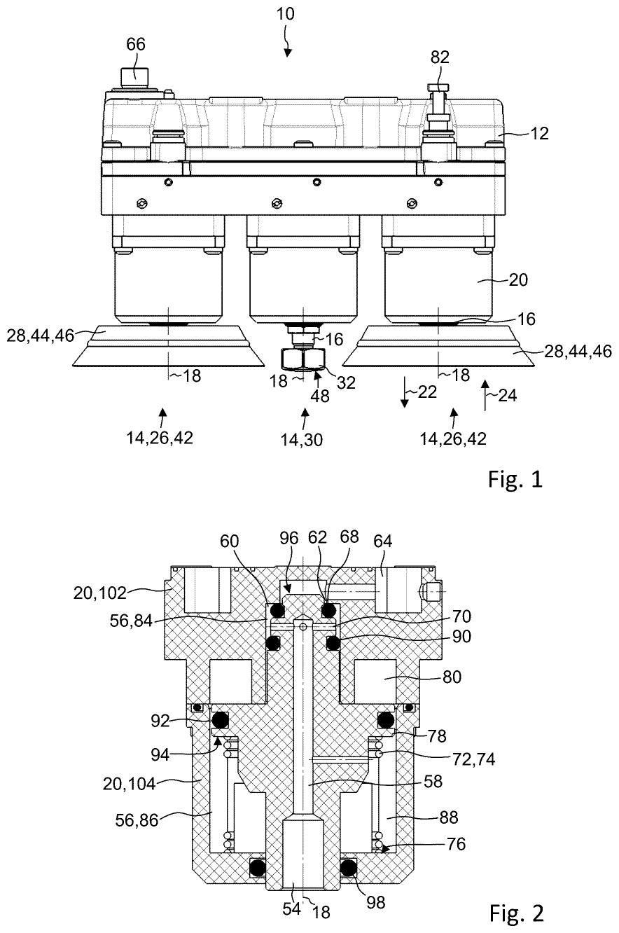

FIG. 1 is a graphic representation of an exemplary embodiment of a gripping apparatus in a side view;

FIG. 2 is a graphic representation of a lifting unit in a sectional view;

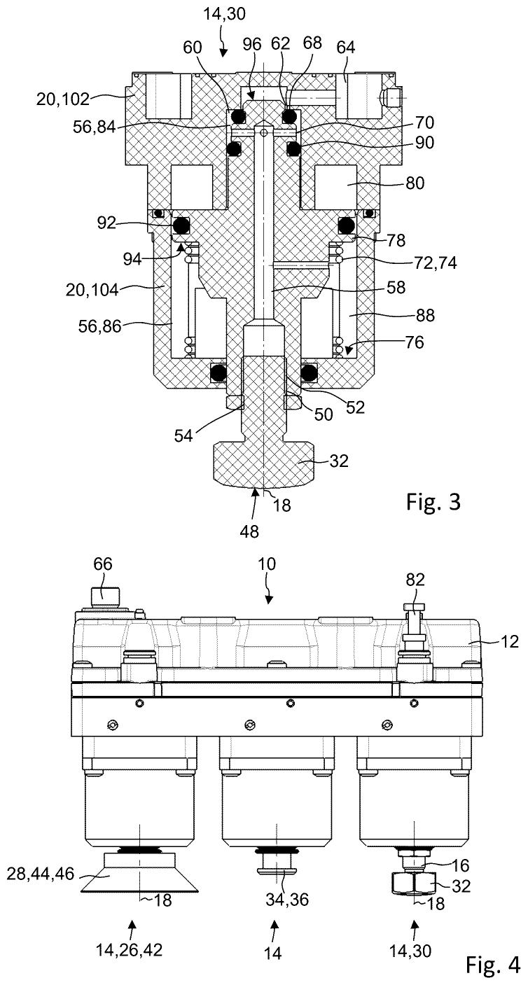

FIG. 3 is a graphic representation of a lifting unit designed as a compressing unit in a sectional view;

FIG. 4 is a graphic representation of a further exemplary embodiment of a gripping apparatus in a side view;

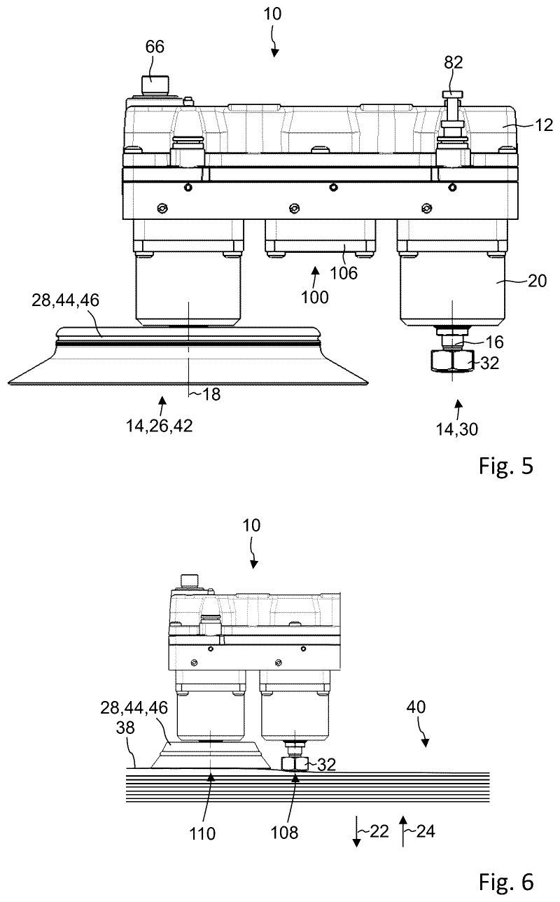

FIG. 5 is a graphic representation of a further exemplary embodiment of a gripping apparatus in a side view; and

FIG. 6 is a graphic representation of an exemplary application situation of a gripping apparatus.

In the following description and in the figures, identical reference signs are in each case used for identical or corresponding features.

FIG. 1 shows an exemplary embodiment of a gripping apparatus, which is denoted as a whole by reference sign 10.

The gripping apparatus 10 comprises a gripper base body 12 and three lifting units 14 mounted on the gripper base body 12. In embodiments not shown, more or fewer lifting units 14 may be provided.

Each lifting unit 14 comprises a lifting piston 16 which is adjustable along a lifting axis 18 between an axially retracted configuration and an axially extended configuration relative to the gripper base body 12. Preferably, the lifting piston 16 can be moved from the retracted configuration to the extended configuration through actuation by compressed air (described in detail below).

In the example, each lifting piston 16 is mounted in a corresponding lifting unit housing 20 so as to be displaceable along the lifting axis 20 in an extension direction 22 and in a retraction direction 24 opposite to the extension direction 22.

In the exemplary configuration according to FIG. 1, the two outer lifting units 14 are designed as gripping units 26, each with a gripper 28 for gripping an item, and the central lifting unit 14 is designed as a compressing unit 30 with a compressing element 32 (without gripping action). In other embodiments, however, any other configurations are also conceivable (see for example FIGS. 4 and 5).

Preferably, gripping unit 26 and compressing unit 30 differ only in the type of attachment (gripper 28 or compressing element 32), but are otherwise identical to one another.

For example, the lifting pistons 16 can have a coupling device 34, for example in the form of an interchangeable coupling 36, to which a gripper 38 or a compressing element 32 can be selectively coupled (see FIG. 4).

In embodiments not shown, however, it is also conceivable that the gripping unit 26 and compressing unit 26 have different designs.

As explained in more detail below with reference to FIG. 6, such a gripping apparatus 10 with gripping unit 26 and compressing unit 30 makes it possible to grip a flat material 38 item from a flat material stack 40 and to deform it locally such that adhesion of a flat material item underneath due to adhesion forces is prevented. The gripping apparatus 10 is therefore particularly suitable for separating stacked flat materials 38, for example sheets.

In the examples shown, the gripping units 26 are designed as suction gripping units 42, each with a suction gripper 44 for suctioning an item. In embodiments not shown, however, it is also conceivable, for example, that a subset of the gripping units 26 or all gripping units 26 are designed as magnetic gripping units with a magnetic gripper as gripper 28.

In the example according to FIG. 1, the suction grippers 44 are designed as elastomer suction bodies 46, wherein the suction bodies 46 of the two gripping units 26 are designed identically to one another. In other embodiments (see, for example, FIGS. 4 and 5), it is also conceivable that suction bodies 46 of different sizes are provided. It is also conceivable that different types of suction grippers are combined with one another.

As explained in detail below, the suction gripper 44 can preferably be supplied with a negative pressure through the lifting piston 16.

In the example shown in FIG. 1, the compressing element 32 is designed as a compressing pin with a contact surface 48, in particular orthogonal to the lifting axis 18, for contact with the item. As can be seen from FIG. 3, the contact surface 48 can be rounded, i.e., can have a curvature with respect to the lifting axis 20.

The compressing element 32 is preferably designed to be insertable or screwable into the lifting piston 16, in particular such that a position of the compressing element 32 along the lifting axis 18 can be changed. In the example according to FIG. 3, the compressing element 32 has a threaded portion 50 which interacts with an internal thread 52 provided in the lifting piston 16. In the example, the internal thread 52 delimits a suction opening 54 of the lifting piston 16, which is sealed by the compressing element 32 (described in detail below).

An exemplary configuration of a lifting unit 14 is explained below with reference to FIG. 2.

As mentioned above, the lifting unit 14 has a lifting unit housing 20 which extends longitudinally along the lifting axis 18. The lifting unit housing 20 delimits a housing interior 56 in which the lifting piston 16 is guided so as to be displaceable along the lifting axis 18.

As can be seen from FIG. 1, the lifting unit housings 20 are preferably mounted next to one another on the gripper base body 12 such that the lifting axes 18 of the individual lifting units 14 run parallel to one another.

As mentioned above, the lifting piston 16 has an internal negative pressure channel 58 which opens with a suction opening 54 at the free axial end of the lifting piston 16.

If the lifting unit 14 is designed as a suction gripping unit 42 with a suction gripper 44, the suction opening 54 of the negative pressure channel 58 is connected in terms of flow to the suction gripper 44, so that the suction gripper 44 can be supplied with negative pressure via the negative pressure channel 58.

When the lifting unit 14 is designed as a compressing unit 32, the suction opening 54 is closed and thus sealed, in particular by the compressing element 32 (see FIG. 3 and the explanations above).

In the example, the negative pressure channel 58 is supplied with negative pressure via a first negative pressure chamber 60 formed in the housing interior 56, which chamber can be supplied with negative pressure via a chamber opening 62 with a negative pressure distribution system 64 (not shown in detail). The negative pressure distribution system 64 is connected to an external negative pressure supply in particular via a negative pressure connection 66 provided on the gripper base body 12.

As can be seen from FIG. 2, the chamber opening 62 is sealed in the axially retracted configuration (passive configuration) by a first sealing device 68 arranged on the lifting piston 16, so that a negative pressure supply to the first negative pressure chamber 60 and thus to the negative pressure channel 58 and thus to the suction gripper 44 is blocked. By displacing the lifting piston 16 in the extension direction 22, the first sealing device 68 is lifted from the chamber opening 62, so that negative pressure can flow via the negative pressure distribution system 64 into the first negative pressure chamber 60 and from there via a radial supply channel 70 into the negative pressure channel 58. In the extended configuration, the suction gripper 44 then assumes an active configuration in which the suction gripper 44 is supplied with negative pressure and can thus suction an item.

In the example, the lifting piston 16 is moved into the retracted configuration by a spring device 72. The spring device 72 comprises a compression spring 74. The compression spring 74 is supported with a first end on an inner housing wall 76 of the lifting unit housing 20 and with the second end on a radial projection 78 of the lifting piston 16 (for the sake of clarity, only a part of the spring 74 is shown in the figures).

In order to transfer the lifting piston 16 from the retracted configuration-against the spring action-into the extended configuration, and thus to lift the first sealing device 68 from the chamber opening 62, a positive pressure chamber 80 is also provided in the housing interior 56, and by applying compressed air to said chamber, the lifting piston 16 is acted upon in the extension direction 22.

For this purpose, the gripping apparatus 10, preferably on the gripper base body 12, also has a compressed air connection 82 and a compressed air distribution system (not shown in detail) for distributing compressed air to the individual lifting units 14.

As mentioned above, the gripping apparatus 10, in particular in the gripper base body 12, can also comprise one or more valve devices (not shown) for controlling a compressed air supply and/or one or more valve devices for controlling a negative pressure supply to the lifting units 14. The gripping apparatus 10 can also have an integrated control device (not shown) for controlling the valve device(s).

The lifting unit 14 shown in FIG. 2 is designed such that when the chamber opening 62 of the first negative pressure chamber 60 is opened, the lifting piston 16 is pulled in the extension direction 22, or is held in the extended configuration, by the effect of the negative pressure. This self-holding function, which is described in more detail below, is advantageous but not mandatory for the embodiment according to the invention.

Specifically, the housing interior 56 has a first housing interior portion 84 and a second housing interior portion 86 arranged behind it in the extension direction 22, wherein, viewed along the lifting axis 18, a cross-sectional area of the first housing interior portion 84 is smaller than a cross-sectional area of the second housing interior portion 86 (cf. FIG. 2).

As shown in FIG. 2, the lifting piston 16 is designed such that the housing interior 56 is divided into the first negative pressure chamber 60, a second negative pressure chamber 88, and the above-mentioned positive pressure chamber 80, wherein in the example the positive pressure chamber 80 is arranged between the first negative pressure chamber 60 and the second negative pressure chamber 88. The chambers 60, 80, 88 can be changed in size by changing a displacement position of the lifting piston 16 along the lifting axis 18.

In the specific example, the lifting piston 16 separates, using a second sealing device 90, a region of the first housing interior portion 84, which forms the first negative pressure chamber 60. In the second housing interior portion 86, the above-mentioned radial projection 78 divides the second housing interior portion 86 into the positive pressure chamber 80 and the second negative pressure chamber 88. To seal the positive pressure chamber 80 from the second negative pressure chamber 88, a third sealing device 92, for example in the form of an O-ring, is provided.

The first negative pressure chamber 60 and the second negative pressure chamber 88 are connected to one another in terms of flow via the negative pressure channel 58, so that the second negative pressure chamber 88 can be supplied with negative pressure via the first negative pressure chamber 60 and the negative pressure channel 58. In particular, the same pressure always prevails in the first negative pressure chamber 60 and in the second negative pressure chamber 88. The negative pressure channel 58 can thus bypass the positive pressure chamber 80.

If the positive pressure chamber 80 is at least briefly pressurized with compressed air, the compressed air acts on the lifting piston 16, in particular the radial projection 78, so that the lifting piston 16 is moved in the extension direction 22 against the spring action of the compression spring 74, and thus the chamber opening 62 is opened as described above. As a result, negative pressure is fed into the first negative pressure chamber 60 and finally via the negative pressure channel 58 into the second negative pressure chamber 88 (and optionally into the suction gripper 44).

The negative pressure chambers 60, 88 and the lifting piston 16 are dimensioned such that the negative pressure then present in the negative pressure chambers 60, 88 exerts a force in the extension direction 22 on the lifting piston 16. In the example, this is achieved in that the lifting piston 16 has first surface portions 94 which are oriented such that the negative pressure prevailing in the negative pressure chambers 60, 88 acts on the first surface portions 94, exerting a force on the lifting piston 16 in the extension direction 22. In the example, such first surface portions 94 are formed for example by the axial end faces of the radial projection 78, which delimit the second negative pressure chamber 88.

In addition, second surface portions 96 are provided which are oriented such that the negative pressure prevailing in the negative pressure chambers 60, 88 acts on the second surface portions 96, exerting a force on the lifting piston 16 in the retraction direction 24. In the example, such second surface portions 96 are formed for example by the axial end face of the lifting piston 16, which delimit the first negative pressure chamber 60.

A sum of all first surface portions 94 is greater than a sum of all second surface portions 96, so that a net force acts on the lifting piston 16 in the extension direction 22. This force is thus superimposed on a force resulting from the application of compressed air.

In order to prevent leakage of negative pressure, in the example optional additional sealing devices 98 are provided which seal the lifting piston 16 from the housing 20.

FIGS. 4 and 5 show further exemplary embodiments of a gripping apparatus 10 with different arrangements and designs of gripping units 26 and compressing units 30.

FIG. 4 shows an embodiment in which no gripper 28 or compressing element 32 is arranged on the central lifting unit 14, so that the above-mentioned coupling device 34 is visible.

FIG. 5 shows an embodiment in which the left lifting unit 14 is designed as a gripping unit 26 with a comparatively large, plate-shaped suction body 46, and the right lifting unit is designed as a compressing unit 30 with a compressing element 32.

The central lifting unit 14, on the other hand, is designed as a blind unit 100 without a lifting piston 16.

As can be seen from FIG. 2, the lifting unit housing 20 is preferably formed in two parts, with a base portion 102 fastened to the gripper base body 12 or formed integrally with the gripper base body 12 and an attachment 104, in the example pot-shaped, fastened to the base portion 102.

In the central lifting unit 14 (blind unit 100) in FIG. 5, the attachment 104 and the lifting piston 16 are removed and instead the base portion 102 is closed with a cover plate 106. The cover plate 106 is preferably fastened to the base portion 102 in a fluid-tight manner, so that the first housing interior portion 84 with the first negative pressure chamber 60 and the positive pressure chamber 80 are separated from one another in terms of flow. In this way, a negative pressure in the negative pressure distribution system 64 or compressed air in the compressed air distribution system can be maintained even without the lifting piston 16.

An exemplary application situation of a gripping apparatus 10 described above is explained below with reference to FIG. 6, wherein only one gripping unit 26 and one compressing unit 30 are considered, in a simplified manner.

FIG. 6 shows a flat material stack 40 with a plurality of flat materials 38 stacked on top of one another, for example in the form of sheets. As shown in FIG. 6, when the uppermost flat material 38 is lifted, it is deformed locally between the suction gripper 44 and the compressing unit 30, thus preventing the underlying flat material 38 from sticking due to adhesion forces.

FIG. 6 shows a configuration in which a deformation occurs due to a relative movement of the item (flat material 38) and the compressing element 32 during a process of suctioning the item with the suction gripper 44. Specifically, the compressing element 32 rests against a first portion 108 of the flat material 38 and the suction gripper 44 rests against a second portion 110 of the flat material 38 spaced from the first portion. When the flat material 38 is suctioned by the suction gripper 44, the second portion 110 is then moved in the retraction direction 24 and thus displaced relative to the first portion 108, so that the flat material 38 is locally deformed (the deformation shown in FIG. 6 is not shown to scale).

As mentioned above, it is however also conceivable that the suction gripper 44 is first extended, suctions the sheet 38, and only then is the compressing unit 30 extended in order to exert a pressure force on the flat material 38 in the extension direction.

1. A gripping apparatus for gripping and handling an item or a flat material, the gripping apparatus comprising:
a gripper base body, and
at least two lifting units arranged on the gripper base body, each comprising a lifting piston which is adjustable along a lifting axis between an axially retracted configuration and an axially extended configuration, wherein
at least one lifting unit is designed as a gripping unit, including a gripper which is coupled in terms of movement to the lifting piston for gripping the item, and
at least one lifting unit is designed as a compressing unit, including a compressing element which is coupled in terms of movement to the lifting piston for exerting a pressure force on an item held by the gripper.

2. The gripping apparatus according to claim 1, wherein the lifting piston of the at least one gripping unit and the lifting piston of the at least one compressing unit or all lifting pistons, can be actuated independently of one another.

3. The gripping apparatus according to claim 1, wherein the lifting piston of the at least one gripping unit and the lifting piston of the at least one compressing unit or all lifting pistons, are designed identically to one another.

4. The gripping apparatus according to claim 1, wherein the lifting pistons each have a coupling device or an interchangeable bushing, at their free ends for selectively coupling a gripper or a compressing element.

5. The gripping apparatus according to claim 1, wherein at least one gripping unit and at least one compressing unit are designed in such a way, that in the extended configuration a contact surface of the compressing element for contact with the item protrudes axially beyond a contact surface of the gripper for contact with the item.

6. The gripping apparatus according to claim 1, wherein the compressing element is mounted on the lifting piston such that the position of the compressing element along the lifting axis is adjustable, or is designed to be mountable on the lifting piston in different positions along the lifting axis.

7. The gripping apparatus according to claim 1, wherein the gripper can assume a passive configuration in which no gripping force is exerted on an item, and an active configuration in which a gripping force is exerted on the item, wherein the gripping unit is designed such that the gripper is in the passive configuration when the retracted configuration of the lifting piston is used and is transferred to the active configuration by extending the lifting piston from the retracted configuration to the extended configuration.

8. The gripping apparatus according to claim 1, wherein at least one gripping unit is designed as a suction gripping unit with a suction gripper for suctioning an item.

9. The gripping apparatus according to claim 8, wherein the gripping apparatus or the gripper base body, has a negative pressure connection for connection to a negative pressure supply, wherein the lifting piston of the at least one suction gripping unit or all lifting pistons, each have a negative pressure channel, wherein the at least one suction gripping unit or all lifting units, is designed such that in the extended configuration of the lifting piston a flow connection is established between the negative pressure connection and the negative pressure channel and in the retracted configuration of the lifting piston this flow connection is blocked.

10. The gripping apparatus according to claim 9, wherein the suction gripper can be supplied with negative pressure via the negative pressure channel of the lifting piston connected to the suction gripper.

11. The gripping apparatus according to claim 9, wherein the compressing element seals the negative pressure channel of the lifting piston connected to the compressing element.

12. The gripping apparatus according to claim 1, wherein the gripper of at least one gripping unit is designed as a magnetic gripper.

13. A gripping module comprising a plurality of gripping apparatuses according to claim 1, wherein the gripping apparatuses are connected to one another.

14. A method for handling said item, or for separating stacked flat materials, using said gripping apparatus according to claim 1, the method comprising:
extending the lifting piston of at least one gripping unit,
placing the gripper coupled to the extended lifting piston onto the item to be gripped and gripping the item using the gripper, and
deforming the item, comprising the exerting of a pressure force on the item by at least one compressing unit.

15. The method according to claim 14, wherein after the item has been gripped using the gripper, at least one compressing unit is extended in order to exert the pressure force on the gripped item or wherein at least one compressing unit is extended before the gripper is placed.
